(19) United States
(12) Patent Application Publication
(10) Pub. No.: US 2024/0334228 A1
(43) Pub. Date: Oct. 3, 2024

(54) METHODS AND DEVICES FOR SWITCHING BETWEEN MEASUREMENT GAP AND MEASUREMENT GAP-LESS RECEPTION OF POSITIONING REFERENCE SIGNALS

(71) Applicant: Nokia Technologies Oy, Espoo (FI)

(72) Inventors: Ryan KEATING, Naperville, IL (US); Tao TAO, Shanghai (CN); Hyun-Su CHA, Naperville, IL (US)

(21) Appl. No.: 18/294,038

(22) PCT Filed: Aug. 4, 2021
(86) PCT No.: PCT/CN2021/110436

§ 371 Date: Jan. 31, 2024

(51) Int. Cl. H04W 24/10; H04L 5/00

(52) U.S. Cl. CPC H04W 24/10; H04L 5/0048

(57) ABSTRACT

Disclosed are example embodiments of methods and devices for switching between measurement gap and measurement gap-less reception of positioning reference signals. An example embodiment provides user equipment comprising at least one processor and at least one memory including computer program code stored therein. The at least one memory and the computer program code may be configured to, with the at least one processor, cause the user equipment to receive positioning reference signals in a measurement gap-less mode, transmit a first request of switching to a measurement gap mode to a base station and/or a location server, receive a first switching request response from the base station, and receive the positioning reference signals in the measurement gap mode when the first switching request response indicates that the first switching request is approved.

### TECHNICAL FIELD

Various example embodiments described herein generally relate to communication technologies, and more particularly, to methods and devices for switching between measurement gap and measurement gap-less reception of positioning reference signals.

### BACKGROUND

Several terrestrial network-based positioning schemes have been proposed for position estimation of user equipment (UE) in a wireless communication network, including for example Downlink Time Difference of Arrival (DL-TDOA), Uplink Time Difference of Arrival (UL-TDOA), Downlink Angle of Departure (DL-AoD), Uplink Angle of Arrival (UL-AoA) and Multi-cell Round Trip Time (Multi-RTT). Conventionally, UE is always configured with measurement gaps (MGs) when performing positioning reference signal (PRS) measurements, and during the measurement gaps the UE does not receive or transmit other signals or channels. A measurement gap-less (MG-less) mode may be introduced for the purpose of positioning latency reduction in the future. In the MG-less mode, the UE can perform PRS measurements without the measurement gaps.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of user equipment is provided. The user equipment may comprise at least one processor and at least one memory including computer program code. The at least one memory and the computer program code may be configured to, with the at least one processor, cause the user equipment to receive positioning reference signals in a measurement gap-less mode, transmit a first request of switching to a measurement gap mode to a base station and/or a location server, receive a first switching request response from the base station, and receive the positioning reference signals in the measurement gap mode responsive to the first switching request response indicating that the first switching request is approved.

In a second aspect, an example embodiment of a base station is provided. The base station may comprise at least one processor and at least one memory including computer program code. The at least one memory and the computer program code may be configured to, with the at least one processor, cause the base station to receive a first request of switching to a measurement gap mode from user equipment, and transmit a first switching request response indicating if the first switching request is approved to the user equipment.

In a third aspect, an example embodiment of a location server is provided. The location server may comprise at least one processor and at least one memory including computer program code. The at least one memory and the computer program code may be configured to, with the at least one processor, cause the location server to configure user equipment with a first rule for switching from a measurement gap-less mode to a measurement gap mode and a second rule for switching from the measurement gap mode to the measurement gap-less mode.

Example embodiments of methods, apparatus and computer programs for switching between measurement gap and measurement gap-less reception of the positioning reference signals are also provided. Such embodiments generally correspond to the above example embodiments of the user equipment, the network device and the location server, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a communication network in which example embodiments of the present disclosure can be implemented.

FIG. 2 is a schematic diagram illustrating positioning delay due to positioning reference signal dropping in a measurement gap-less mode.

FIG. 3 is a signaling diagram illustrating operations of switching between measurement gap and measurement gap-less reception of positioning reference signals in accordance with an example embodiment.

FIG. 4 is a schematic diagram illustrating an example switching from the measurement gap-less mode to the measurement gap mode in accordance with an example embodiment.

FIG. 5 is a schematic diagram illustrating an example switching from the measurement gap mode to the measurement gap-less mode in accordance with an example embodiment.

FIG. 6 is a block diagram illustrating a communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “network function (NF)” refers to a processing function in a network, and defines a functional behavior and an interface. The network function may be implemented by using dedicated hardware, or may be implemented by running software on dedicated hardware, or may be implemented on a form of a virtual function on a common hardware platform. From a perspective of implementation, network functions may be classified into a physical network function and a virtual network function. From a perspective of use, network functions may be classified into a dedicated network function and a shared network function.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

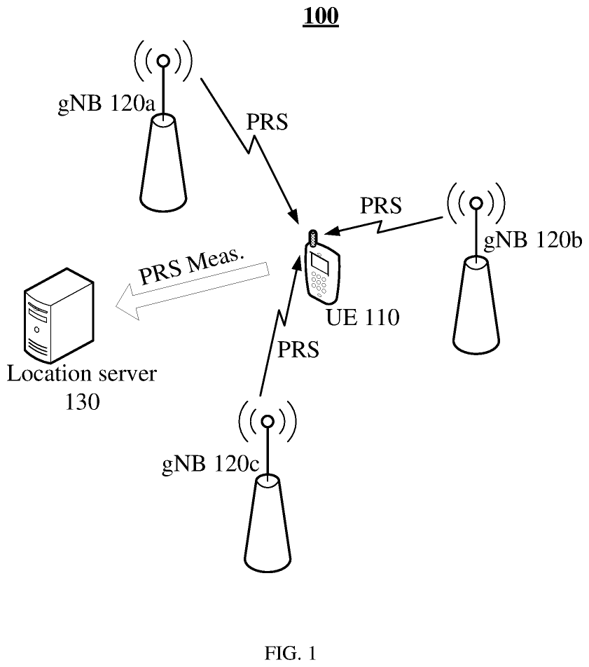

FIG. 1 illustrates a simplified schematic diagram of an example communication network 100 in which example embodiments of the present disclosure may be implemented. Referring to FIG. 1, the communication network 100 may include user equipment (UE) 110 and a plurality of base stations (BSs) (shown as gNBs) 120a, 120b, 120c. The BSs 120 may provide access to network for UEs and are also referred to as a random access network (RAN). For example, the UE 110 may camp in a cell served by one of the BSs 120 e.g. the BS 120a and establish a radio resource control (RRC) connection with the BS 120a. The cell may be referred to as a serving cell for the UE 110, and the BS 120a may be regarded as a reference BS in a positioning procedure for the UE 110. The communication network 100 may further comprise a location server 130, which may be implemented as a physical or logical entity to manage positioning of UEs connected to the network 100. The LS 130 may be implemented inside the RAN as a local location management component (LMC), or implemented as a network function such as a location management function (LMF) within a core network. The BSs 120 may be connected to the core network through so called backhaul connections.

When the UE 110 performs positioning measurement using for example the DL-TDOA method, the UE 110 may receive downlink (DL) positioning reference signals (PRSs) from the BSs 120 and measure arrival time of the PRSs. It would be appreciated that the positioning reference signal mentioned in the present disclosure could be any reference signal that can be used to perform the positioning measurements, examples of which may include the synchronization signals, the cell-specific reference signal, and the positioning reference signal defined in 3GPP specifications. The arrival time of the PRS from the neighboring BS 120b, 120c may be subtracted from the arrival time of the PRS from the reference BS 120a to obtain Downlink Time Difference of Arrival (DL-TDOA). The DL-TDOA measurement, also referred to as Reference Signal Time Difference (RSTD) measurement, may be sent in a PRS measurement report to the LS 130. Once the LS 130 receives the PRS measurement report from the UE 110, it may convert RSTD into a distance difference between a first distance from the UE 110 to the reference BS 120a and a second distance from the UE 110 to the neighboring BS 120b or 120c based on the light speed. Since the LS 130 knows positions of the BSs 120 (or physical antennae of the BSs), the LS 130 can calculate a hyperbola from a distance difference between the neighboring BS and the reference BS, and an intersecting point of two or more such hyperbolas corresponds to an estimated position of the UE 110. Here the DL-TDOA method is described as an example, and it would be appreciated that example embodiments discussed herein are also applicable to other positioning schemes.

The UE 110 may receive DL PRS configuration for cells served by the BSs 120 from the location server 130 via LTE Positioning Protocol (LPP) signaling. Since the LPP signaling is transparent for the serving BS 120a, the serving BS 120a is not aware of the DL PRS configuration for cells of the neighboring BSs 120b and 120c. When the UE 110 receives the DL PRSs in a measurement gap-less mode, DL signals or channels received from the serving cell may possibly use the same resources as the PRSs received from the neighboring BSs 120b, 120c. Then the UE 110 needs to apply some priority rules to determine how to treat the DL PRSs when the DL PRSs collide with other DL signals or channels. For example, if the DL PRSs collide with a physical downlink shared channel (PDSCH) which has a higher priority than the DL PRSs, the UE 110 would have to drop the DL PRS symbols.

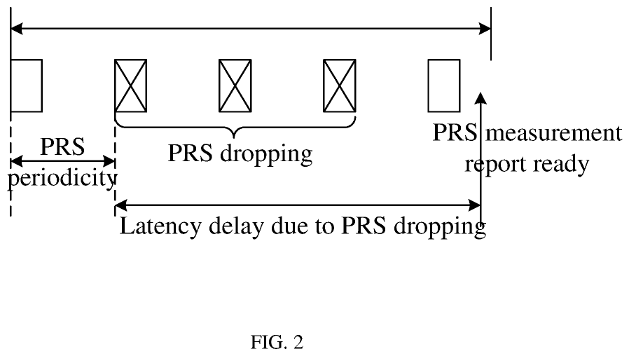

The PRS dropping may increase positioning latency, of which an example is shown in FIG. 2. Referring to FIG. 2, the BSs 120 transmit PRSs using PRS resources with a periodicity. Since the serving BS 120a does not know PRS configurations at the neighboring BSs 120b and 120c, the serving BS 120a may schedule other DL signals or channels at PRS resources for the neighboring BSs 120b and 120c. In the example shown in FIG. 2, it is assumed that the other DL signals or channels scheduled by the serving BS 120a uses the same resources as the PRSs transmitted by the neighboring BSs 120b, 120c at the second, third and fourth PRS occasions, and the other DL signals or channels have a higher priority than the PRSs. Then the UE 110 has to drop the PRSs transmitted from the neighboring BSs 120b, 120c at the second to fourth PRS occasions. If the PRSs in two PRS occasions are needed to generate a PRS measurement report, the UE 110 cannot generate the PRS measurement report until it receives the PRSs in the fifth PRS occasion. As seen, the PRS dropping increases the positioning latency of the UE 110. This is a problem as a positioning QoS flow may have a latency requirement which could be strict for some positioning applications.

Hereinafter, example embodiments of methods and devices for switching between measurement gap and measurement gap-less reception of the PRSs would be described in detail with reference to the drawings. When UE operates in the measurement gap-less mode and a switching rule is triggered, the UE can seamlessly switch from the measurement gap-less mode to the measurement gap mode. Then the positioning latency increase caused by PRS dropping in the measurement gap-less mode can be avoided. If another switching rule is triggered when the UE operates in the measurement gap mode, the UE can seamlessly switch back to the measurement gap-less mode.

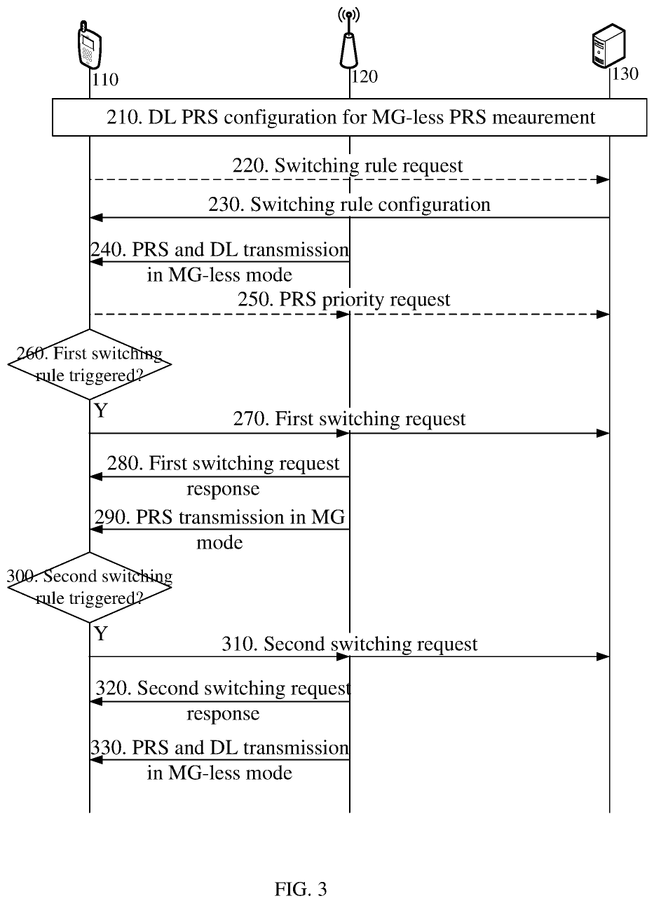

FIG. 3 is a signaling diagram illustrating operations of switching between the measurement gap mode and the measurement gap-less mode in accordance with an example embodiment. The operations shown in FIG. 3 may be performed by user equipment, a base station and a location server in a communication network, for example the UE 110, the BSs 120 and the location server 130 in the communication network 100 described above with reference to FIG. 1. In some example embodiments, the UE 110, the BSs 120 and the location server 130 may include a plurality of means for performing the operations shown in FIG. 3. The means may be implemented in various manners, including software, hardware, firmware, or any combination thereof, to perform the operations.

Referring to FIG. 3, the UE 110 may be configured at 210 with DL PRS configuration for PRS measurement in the measurement gap-less mode. For example, the UE 110 may report its measurement gap-less capability to the serving BS 120a and/or the location server 130, and the BSs 120 may report their DL PRS transmission configurations to the location server 130. Then the location server 130 may determine specific PRS configuration for the UE 110 to receive DL PRSs from the BSs 120 in the measurement gap-less mode. The location server 130 may send the PRS configuration to the UE 110 via LTE Positioning Protocol (LPP) signaling or NR Positioning Protocol A (NRPPa) signaling.

The UE 110 may receive at 230 switching rule configuration from the location server 130. For example, when the location server 130 knows at 210 that the UE 110 has the capability of receiving the PRSs in the measurement gap-less mode, the location server 130 may configure the switching rules for the UE 110. In some example embodiments, optionally, the location server 130 may configure the switching rules for the UE 110 in response to a switching rule request received from the UE 110 at 220. The UE 110 may indicate in the switching rule request desirable switching rules or information for determining the desirable switching rules. For example, the switching rule request may indicate positioning QoS requirements of the UE 110. Then the location server 130 would configure suitable switching rules for the UE 110 based on the received switching rule request.

The switching rules may comprise a first rule for switching from the measurement gap-less mode to the measurement gap mode and a second rule for switching from the measurement gap mode to the measurement gap-less mode. The location server 130 may configure the first and second switching rules by defining one or more switching conditions to trigger the PRS reception mode switching at 230. The switching conditions may be flexibly defined. For example, the location server 130 may define at 230 that the first switching rule is triggered when one or more of following conditions are satisfied: (1) the UE drops a threshold number of PRS occasions or PRS resources within a certain time period in the measurement gap-less mode, (2) the UE drops PRSs in a threshold number of consecutive PRS occasions in the measurement gap-less mode, (3) the UE fails to obtain PRS measurements for a threshold number of transmission reception points (TRPs), e.g. the BSs, in the measurement gap-less mode, (4) the UE fails to obtain PRS measurements for a reference TRP, e.g. the serving BS, 120a or for a reference PRS resource(s), e.g. the PRS resource(s) of the serving BS 120a, above a threshold level of quality in the measurement gap-less mode, (5) the UE fails to obtain PRS measurements for a particular PRS resource(s) indicated by the location server above a threshold level of quality in the measurement gap-less mode, and (6) the UE fails to obtain DL data channel scheduling for a time window in the measurement gap-less mode. When the first switching rule is triggered, the UE 110 can initiate a procedure to switch from the measurement gap-less mode to the measurement gap mode. As another example, the location server 130 may define at 230 that the second switching rule is triggered when one or more of following conditions are satisfied: (1) the UE receives a threshold number of consecutive PRS occasions or PRS resources in the measurement gap mode, (2) the UE receives PRSs for a threshold time period in the measurement gap mode, and/or (3) the UE receives a threshold number of PRS resources within a time period in the measurement gap mode. When the second switching rule is triggered, the UE 110 can initiate a procedure to switch back from the measurement gap mode to the measurement gap-less mode. The above mentioned thresholds may be configured by the location server 130 at the operation 230. The UE 110 may implement one or more timers, counters, and/or comparators to monitor whether or not one or more of the above mentioned conditions are satisfied. It would be appreciated that other conditions may also be defined to trigger the first or second switching rule.

At 240, the UE 110 may receive the PRSs in the measurement gap-less mode according to the PRS configuration for the measurement gap-less mode received in the operation 210. In the measurement gap-less mode, the UE 110 may also receive other DL signals or channels from the serving BS 120a. As discussed above with reference to FIG. 2, the PRSs transmitted from the neighboring BSs 120b, 120c may possibly collide with the other DL signals or channels scheduled by the serving BS 120a. If the DL signals or channels have a higher priority than the PRSs, the UE 110 would have to drop the PRS symbols.

At 250, optionally, the UE 110 may send a PRS priority request to the serving BS 120a and/or the location server 130. The PRS priority request may indicate a particular PRS resource(s) with a high priority. When the serving BS 120a receives the PRS priority request, the serving BS 120a may schedule DL resources for the UE 110 according to the PRS priority request. For example, the serving BS 120a may not schedule DL signals or channels on the PRS resource(s) having the high priority so that the PRS resource(s) would not be dropped at the UE 130 due to collision with other DL signals or channels. The serving BS 120a may also signal the PRS priority request to the location server 130. If the UE 110 sends the PRS priority request to the location server 130, the location server 130 may inform relevant BSs of the PRS priority request, and the relevant BSs, including the serving BS 120a, may take the request into account for subsequent PRS transmissions.

When the UE 110 operates in the measurement gap-less mode, the UE 110 may determine at 260 if or not the first switching rule for switching from the measurement gap-less mode to the measurement gap mode is triggered. For example, if one or more of the above mentioned switching conditions are satisfied, the UE 110 determines that the first switching rule is triggered. Then the UE 110 may initiate a procedure to switch from the measurement gap-less mode to the measurement gap mode. If the first switching rule is not triggered, the UE 110 may continue the measurement gap-less mode for reception of the PRSs.

As discussed above, the PRS priority request transmitted in the operation 250 may delay triggering the first switching rule by reducing or avoiding PRS dropping due to collision with other DL signals or channels. When the first switching rule is eventually triggered at 260, the UE 110 may decide to switch to the measurement gap mode despite the PRS resource(s) having the high priority. In some other example embodiments, the UE 110 may want to keep in the measurement gap-less mode even if the first switching rule is triggered. For example, the UE 110 has an important positioning session being performed in the measurement gap-less mode and does not want to switch to the measurement gap mode until the positioning session is completed. Then when the first switching rule is triggered, the UE 110 may perform the operation 250 of transmitting the PRS priority request to protect one or more PRS resources received in the measurement gap-less mode. The PRS priority request may be a single bit PRS priority request, or the PRS priority request may indicate one or more PRS resources with a high priority. The BSs 120 and the location server 130 can know from the PRS priority request that the UE 110 wants to keep in the measurement gap-less mode and would take the request into account for subsequent DL PRS transmissions. In some example embodiments, the location server 130 may configure the UE 110 to report PRS resources and/or PRS resource set(s) if the UE 110 keeps in the measurement gap-less mode even when the switching rule is triggered.

At 270, the UE 110 may initiate a PRS reception mode switching procedure by transmitting a first switching request to the serving BS 120a and/or the location server 130. The first switching request may indicate that the UE 110 wants to switch to the measurement gap mode. The UE 110 may send the first switching request when the first switching rule is triggered, or even when the first switching rule is not triggered but the UE 110 wants to switch to the measurement gap mode. In some example embodiments, the UE 110 may send the first switching request to the serving BS 120a in order to save time and switch quickly. The first switching request may be sent via Uplink Control Information (UCI), a Medium Access Control Element (MAC CE), LTE Positioning Protocol (LPP) signaling, and/or NR Positioning Protocol A (NRPPa) signaling. If the first switching request is sent via UCI or MAC CE, the serving BS 120a may forward the request to the location server 130. When the serving BS 120a approves the first switching request from the UE 110, the serving BS 120a may send a first switching message indicating that the UE 110 switches to the measurement gap mode to the location server 130. The first switching message may be sent via LPP signaling and/or NRPPa signaling. In some example embodiments, the UE 110 may send the first switching request to the location server 130 via the LPP signaling and/or NRPPa signaling. Then the location server 130 may inform the serving BS 120a of the PRS reception mode switching request from the UE 110. If the serving BS 120a approves the switching request of the UE 110, the location server 130 may adjust the PRS configuration for the UE 110 if needed, for example if the UE 110 has different DL PRS processing capabilities in the measurement gap-less mode and the measurement gap mode.

In some example embodiments, the first switching request may further indicate a desirable measurement gap for the UE 110. The desirable measurement gap may be determined by the UE 110 based on the positioning QoS requirements or selected from one or more measurement gaps pre-configured at the UE 110. Then the serving BS 120a may determine a suitable measurement gap for the UE 110 based on the first switching request. It would be appreciated that the measurement gap determined by the serving BS 120a may be the same as or different from the desirable measurement gap requested by the UE 110.

In response to the first switching request, the serving BS 120a may send a first switching request response to the UE 110 at 280. If the UE 110 is pre-configured with one or more measurement gaps, the first switching request response may include a single ACK or NACK bit to indicate if the first switching request from the UE 110 is approved or rejected by the serving BS 120a. The serving BS 120a may reject the switching request of the UE 110 when for example the serving BS 120a has urgent DL data for the UE 110. If the switching request is approved, the UE 110 may select and activate a pre-configured measurement gap and enter into the measurement gap mode. In some example embodiments, the first switching request response may further indicate a measurement gap to be activated at the UE 110, and the measurement gap to be activated may be selected from the one or more measurement gaps pre-configured for the UE 110. In some example embodiments, the UE 110 may not be pre-configured with a measurement gap. Then the serving BS 120a may configure a measurement gap for the UE 110 and send the measurement gap configuration to the UE 110 in the first switching request response. The measurement gap configuration may be transmitted to the serving BS 120a via an RRC signaling, an MAC CE and/or Downlink Control Information (DCI).

If the serving BS 120a approves the first switching request from the UE 110 in the operation 280, then the UE 110 may switch at 290 to the measurement gap mode and receive only the PRSs during the measurement gap. The UE 110 does not receive or transmit other signals or channels during the measurement gap. Since the serving BS 120a is aware of the measurement gap configuration for the UE 110, the serving BS 120a may not schedule other signal or channel transmissions during the measurement gap.

The above described is a procedure for switching from the measurement gap-less mode to the measurement gap mode. After operating in the measurement gap mode for a while, the UE 110 may possibly want to switch back to the measurement gap-less mode. Hereinafter a procedure for switching from the measurement gap mode to the measurement gap-less mode will be described with continuous reference to FIG. 3.

At 300, when the UE 110 operates in the measurement gap mode, the UE 110 may determine if or not the second switching rule for switching from the measurement gap mode to the measurement gap-less mode is triggered. For example, if one or more of the switching conditions for switching to the measurement gap-less mode configured by the location server 130 in the operation 230 are satisfied, the UE 110 may determine that the second switching rule is triggered. Then the UE 110 may initiate a procedure to switch from the measurement gap mode to the measurement gap-less mode. If the second switching rule is not triggered, the UE 110 may continue the measurement gap mode for reception of the PRSs.

At 310, the UE 110 may initiate a PRS reception mode switching procedure by transmitting a second switching request to the serving BS 120a and/or the location server 130. The second switching request may indicate that the UE 110 wants to switch to the measurement gap-less mode. The UE 110 may send the second switching request when the second switching rule is triggered, or even when the second switching rule is not triggered but the UE 110 wants to switch to the measurement gap-less mode. For example, when the UE 110 does not have or has a small volume of other DL signal or channel transmissions, the UE 110 may decide to switch to the measurement gap-less mode. In some example embodiments, the UE 110 may send the second switching request to the serving BS 120a in order to save time and switch quickly. The second switching request may be sent via Uplink Control Information (UCI), a Medium Access Control Element (MAC CE), LTE Positioning Protocol (LPP) signaling, and/or NR Positioning Protocol A (NRPPa) signaling. If the second switching request is sent via UCI or MAC CE, the serving BS 120a may forward the request to the location server 130. When the serving BS 120a approves the second switching request from the UE 110, the serving BS 120a may send a second switching message indicating that the UE 110 switches to the measurement gap-less mode to the location server 130. The second switching message may be sent via LPP signaling and/or NRPPa signaling. In some example embodiments, the UE 110 may send the second switching request to the location server 130 via the LPP signaling and/or NRPPa signaling. Then the location server 130 may inform the serving BS 120a of the PRS reception mode switching request from the UE 110. If the serving BS 120a approves the switching request of the UE 110, the location server 130 may adjust the PRS configuration for the UE 110 if needed, for example if the UE 110 has different DL PRS processing capabilities in the measurement gap-less mode and the measurement gap mode.

In response to the second switching request, the serving BS 120a may send a second switching request response to the UE 110 at 320. The second switching request response may include a single ACK or NACK bit to indicate if the second switching request from the UE 110 is approved or rejected by the serving BS 120a. The serving BS 120a may reject the switching request of the UE 110 when for example the serving BS 120a has to allocate a large volume of resources for DL signals or channels and the DL signals and channels would likely collide the DL PRSs. If the switching request is rejected, the UE 110 may keep in the measurement gap mode

If the switching request is approved, the UE 110 may deactivate the measurement gap configuration and enter into the measurement gap-less mode at 330. In some example embodiments, the deactivated measurement gap configuration may be maintained at the UE 110 and it may be activated again when the UE 110 switches to the measurement gap mode.

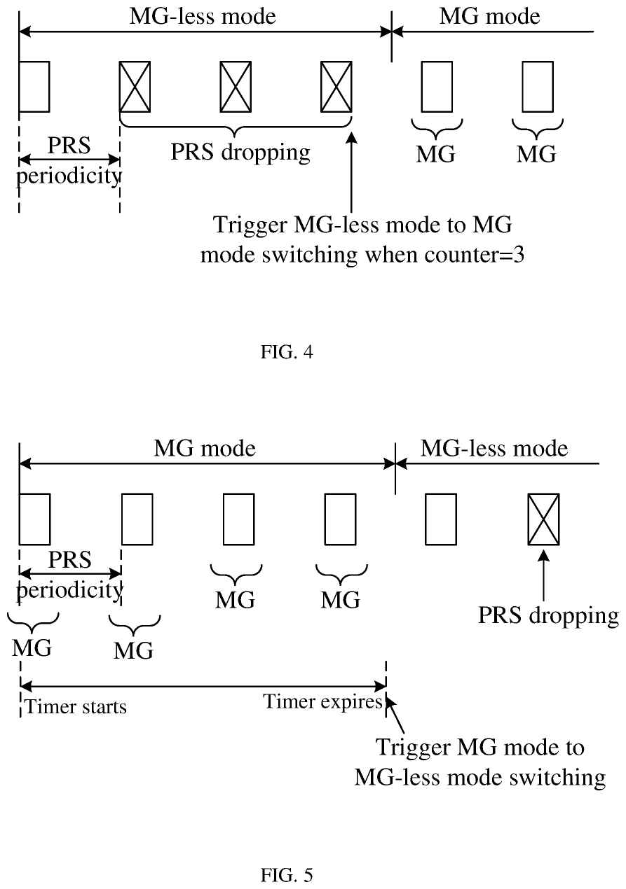

FIG. 4 is a schematic diagram illustrating an example procedure for switching from the measurement gap-less mode to the measurement gap mode in accordance with an example embodiment. The example switching procedure may be implemented by operations shown in FIG. 3. Referring to FIG. 4, the UE 110 may be configured with PRS occasions having a periodicity. In the measurement gap-less mode, when the PRS resources collide with DL signals or channels having a higher priority, the UE 110 would have to drop the colliding PRS resources. In the example embodiment shown in FIG. 4, the UE 110 may operate a counter to counter a number of consecutive PRS resources or PRS occasions dropped by the UE 110. If a PRS resource or occasion is not dropped, the counter may be reset to zero. When the counting number reaches a predetermined value for example 3 in the example of FIG. 4, the UE 110 may trigger the measurement gap-less mode to measurement gap mode switching. As discussed above, the UE 110 may send a switching request to the serving BS 120a. The serving BS 120a may approve the switching request and configure a measurement gap for the UE 110. Then the UE 110 would apply the measurement gap to measure the PRSs. There are no other DL signals or channels are scheduled during the measurement gap, and the PRS resources would not be dropped due to collision in the measurement gap mode.

FIG. 5 is a schematic diagram illustrating an example procedure for switching from the measurement gap mode to the measurement gap-less mode in accordance with an example embodiment. The example switching procedure may be implemented by operations shown in FIG. 3. Referring to FIG. 5, the UE 110 may be configured with a measurement gap to receive PRS resources at respective PRS occasions having a periodicity. During the measurement gap the UE 110 does not receive other DL signals or channels and thus the PRS resources would not collide with other DL signals or channels. In the example embodiment shown in FIG. 5, the UE 110 may start a timer when the UE 110 switches to or initiate the measurement gap mode. When the timer expires, the UE 110 may trigger the measurement gap mode to measurement gap mode switching. As discussed above, the UE 110 may send a switching request to the serving BS 120a. If the serving BS 120a approves the switching request from the UE 110, the UE 110 may deactivate the measurement gap configuration and receive the PRSs without the measurement gap.

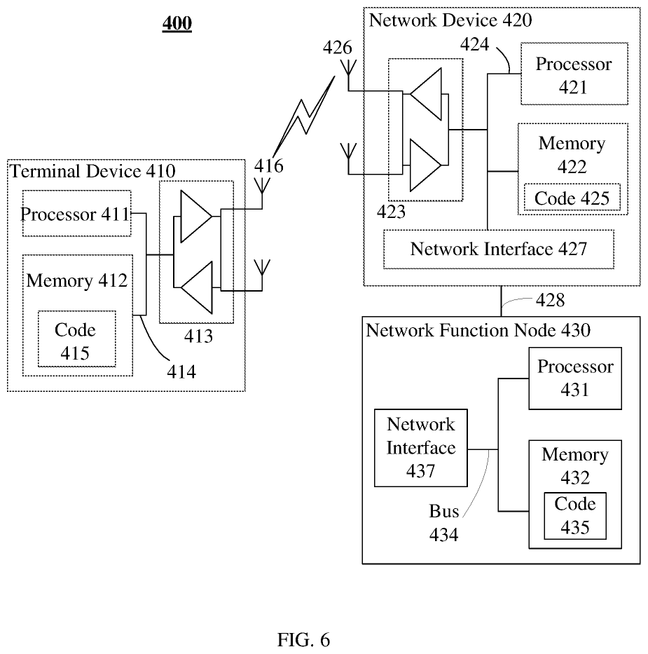

FIG. 6 illustrates a block diagram of an example communication system 400 in which embodiments of the present disclosure can be implemented. As shown in FIG. 6, the communication system 400 may comprise a terminal device 410 which may be implemented as the UE 110 discussed above, a network device 420 which may be implemented as the BS 120 discussed above, and a network function node 430 which may be implemented as the location server 130 discussed above. In some example embodiments, alternatively, the location server 130 may be implemented as a component or part in the network device 420. Although FIG. 6 shows one network device 420, it would be appreciated that the communication system 400 may comprise a plurality of network devices 420 to position or assist positioning of the UE 410.

Referring to FIG. 6, the terminal device 410 may comprise one or more processors 411, one or more memories 412 and one or more transceivers 413 interconnected through one or more buses 414. The one or more buses 414 may be address, data, or control buses, and may include any interconnection mechanism such as series of lines on a motherboard or integrated circuit, fiber, optics or other optical communication equipment, and the like. Each of the one or more transceivers 413 may comprise a receiver and a transmitter, which are connected to one or more antennas 416. The terminal device 410 may wirelessly communicate with the network device 420 through the one or more antennas 416. The one or more memories 412 may include computer program code 415. The one or more memories 412 and the computer program code 415 may be configured to, when executed by the one or more processors 411, cause the terminal device 410 to perform operations and procedures relating to the UE 110 as described above.

The network device 420 may comprise one or more processors 421, one or more memories 422, one or more transceivers 423 and one or more network interfaces 427 interconnected through one or more buses 424. The one or more buses 424 may be address, data, or control buses, and may include any interconnection mechanism such as a series of lines on a motherboard or integrated circuit, fiber, optics or other optical communication equipment, and the like. Each of the one or more transceivers 423 may comprise a receiver and a transmitter, which are connected to one or more antennas 426. The network device 420 may operate as a BS for terminal device 410 and wirelessly communicate with terminal device 410 through the one or more antennas 426. The one or more network interfaces 427 may provide wired or wireless communication links through which the network device 420 may communicate with other network devices, entities, elements or functions. The one or more memories 422 may include computer program code 425. The network device 420 may communicate with the network function node 430 via backhaul connections 428. The one or more memories 422 and the computer program code 425 may be configured to, when executed by the one or more processors 421, cause the network device 420 to perform operations and procedures relating to the BSs 120 such as the serving BS 120a as described above.

The network function node 430 may comprise one or more processors 431, one or more memories 432, and one or more network interfaces 437 interconnected through one or more buses 434. The one or more buses 434 may be address, data, or control buses, and may include any interconnection mechanism such as a series of lines on a motherboard or integrated circuit, fiber, optics or other optical communication equipment, and the like. The network function node 430 may operate as a core network function node and wired or wirelessly communicate with the network device 420 through one or more links. The one or more network interfaces 437 may provide wired or wireless communication links through which the network function node 430 may communicate with other network devices, entities, elements or functions. The one or more memories 432 may include computer program code 435. The one or more memories 432 and the computer program code 435 may be configured to, when executed by the one or more processors 431, cause the network function node 430 to perform operations and procedures relating to the location server 130 as described above.

The one or more processors 411, 421 and 431 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 1011, 1021 and 1031 may be configured to control other elements of the UE/network device/network element and operate in cooperation with them to implement the procedures discussed above.

The one or more memories 412, 422 and 432 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 1012, 1022 and 1032 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

Abbreviations used in the description and/or in the figures are herewith defined as follows:
ACK Acknowledgement
BS Base Station
CN Core Network
DCI Downlink Control Information
DL Downlink
gNB NR Base Station
LMC Location Management Component
LMF Location Management Function
LTE Long Term Evolution
MG Measurement Gap
NF Network Function
NR New Radio
PRS Positioning Reference Signal
RAN Radio Access Network
RSTD Reference Signal Time Difference
UE User Equipment

1-65. (canceled)

66. User equipment comprising:
at least one processor; and
at least one memory including computer program code, the at least one memory and the computer program code configured to, with the at least one processor, cause the user equipment to:
receive positioning reference signals in a measurement gap-less mode;
transmit a first request of switching to a measurement gap mode to a base station and/or a location server;
receive a first switching request response from the base station; and
receive the positioning reference signals in the measurement gap mode responsive to the first switching request response indicating that the first switching request is approved.

67. The user equipment of claim 66, wherein the first switching request is transmitted when a first switching rule is triggered.

68. The user equipment of claim 67, wherein the first switching rule is triggered when one or more of following conditions are satisfied:
the user equipment drops a first threshold number of positioning reference signal occasions or positioning reference signal resources within a time period in the measurement gap-less mode;
the user equipment drops positioning reference signals in a second threshold number of consecutive positioning reference signal occasions in the measurement gap-less mode;
the user equipment fails to obtain positioning reference signal measurements for a third threshold number of transmission reception points (TRPs) in the measurement gap-less mode;
the user equipment fails to obtain positioning reference signal measurements for a reference transmission reception point or positioning reference signal resource above a fourth threshold level of quality in the measurement gap-less mode;
the user equipment fails to obtain positioning reference signal measurements for a positioning reference signal resource indicated by the location server above a fifth threshold level of quality in the measurement gap-less mode; and
the user equipment fails to obtain downlink data channel scheduling for a time window in the measurement gap-less mode.

69. The user equipment of claim 66, wherein the at least one memory and the computer program code are further configured to, with the at least one processor, cause the user equipment to:
transmit a positioning reference signal priority request to the base station and/or the location server before transmitting the first switching request.

70. The user equipment of claim 69, wherein the positioning reference signal priority request specifies positioning reference signal resources with priority.

71. The user equipment of claim 66, wherein the first switching request response comprises a measurement gap configuration for the user equipment.

72. The user equipment of claim 71, wherein the measurement gap configuration is received via a Radio Resource Control (RRC) signaling, a Medium Access Control Control Element (MAC CE), and/or Downlink Control Information (DCI).

73. The user equipment of claim 66, wherein the first switching request response indicates a measurement gap to be activated at the user equipment, the measurement gap to be activated is selected from one or more measurement gaps pre-configured for the user equipment.

74. The user equipment of claim 66, wherein the first switching request indicates a measurement gap suitable for the user equipment.

75. The user equipment of claim 66, wherein the at least one memory and the computer program code are further configured to, with the at least one processor, cause the user equipment to:
transmit a second request of switching to the measurement gap-less mode to the base station;
receive a second switching request response from the base station; and
receive the positioning reference signals in the measurement gap-less mode responsive to the second switching request response indicating that the second switching request is approved.

76. The user equipment of claim 66, wherein the first switching request and the second switching request are transmitted via Uplink Control Information (UCI), a Medium Access Control Control Element (MAC CE), a Long term evolution Positioning Protocol (LPP) signaling, and/or a New Radio Positioning Protocol A (NRPPa) signaling.

77. The user equipment of claim 75, wherein the second switching request is transmitted when a second switching rule is triggered.

78. The user equipment of claim 77, wherein the second switching rule is triggered when one or more of following conditions are satisfied:
the user equipment receives a sixth threshold number of consecutive positioning reference signal occasions or positioning reference signal resources in the measurement gap mode;
the user equipment receives the positioning reference signals in the measurement gap mode for a seventh threshold time period; and
the user equipment receives an eighth threshold number of positioning reference signal resources in a time period in the measurement gap mode.

79. The user equipment of claim 66, wherein the at least one memory and the computer program code are further configured to, with the at least one processor, cause the user equipment to:
receive a switching rule configuration from the location server.

80. The user equipment of claim 79, wherein the switching rule configuration comprises a first rule for switching from the measurement gap-less mode to the measurement gap mode and a second rule for switching from the measurement gap mode to the measurement gap-less mode.

81. The user equipment of claim 79, wherein the at least one memory and the computer program code are further configured to, with the at least one processor, cause the user equipment to:
transmit a switching rule request to the location server before receiving the switching rule configuration.

82. The user equipment of claim 81, wherein the switching rule request comprises a switching rule suitable for the user equipment or information for determining the switching rule suitable for the user equipment.

83. A base station comprising:
at least one processor; and
at least one memory including computer program code, the at least one memory and the computer program code configured to, with the at least one processor, cause the base station to:
receive a first request of switching to a measurement gap mode from user equipment; and
transmit a first switching request response indicating if the first switching request is approved to the user equipment.

84. The base station of claim 83 wherein the at least one memory and the computer program code are further configured to, with the at least one processor, cause the base station to:
receive a positioning reference signal priority request from the user equipment, the positioning reference signal priority request indicating positioning reference signal resources with priority.

85. A location server comprising:
at least one processor; and
at least one memory including computer program code, the at least one memory and the computer program code configured to, with the at least one processor, cause the location server to:
configure user equipment with a first rule for switching from a measurement gap-less mode to a measurement gap mode and a second rule for switching from the measurement gap mode to the measurement gap-less mode.
